(19) United States
(12) Patent Application Publication
(10) Pub. No.: US 2018/0245665 A1
(43) Pub. Date: Aug. 30, 2018

(54) DEVICE FOR DAMPING TORSIONAL OSCILLATIONS

(71) Applicant: VALEO EMBRAYAGES, Amiens (FR)

(72) Inventors: Michael HENNEBELLE, Amiens (FR); Roel VERHOOG, Amiens (FR); Franck CAILLERET, Amiens (FR); David SALVADORI, Amiens (FR)

(73) Assignee: VALEO EMBRAYAGES, Amiens Cedex 2 (FR)

(21) Appl. No.: 15/749,576

(22) PCT Filed: Jul. 27, 2016
(86) PCT No.: PCT/EP2016/067963

§ 371 Date: Feb. 1, 2018

(30) Foreign Application Priority Data
Aug. 5, 2015 (FR) 1557555

(51) Int. Cl. F16F 15/14; F16F 15/139

(52) U.S. Cl. CPC F16F 15/145; F16F 15/1392; F16F 2224/02; F16F 2222/08; F16F 2224/0208; F16F 2222/04

(57) ABSTRACT

A device for damping torsional oscillations including at least one support being displaced rotationally about an axis, a plurality of pendular bodies, each pendular body being mobile in relation to the support, and a friction-based connection between two circumferentially adjacent pendular bodies.

The present invention relates to a device for damping torsional oscillations, in particular for a motor vehicle transmission system.

In such an application, the device for damping torsional oscillations can be incorporated in a torsion damping system of a clutch capable of selectively linking the heat engine to the gearbox, in order to filter the vibrations due to the rotational irregularities of the engine.

As a variant, in such an application, the device for damping torsional oscillations can be incorporated in a friction clutch disk or in a hydrodynamic torque converter.

Such a device for damping torsional oscillations conventionally implements a support and one or more pendular bodies that are mobile in relation to this support, the displacement in relation to the support of each pendular body being guided by two rolling members cooperating on the one hand with rolling tracks integral to the support, and on the other hand with rolling tracks integral to the pendular bodies. Each pendular body for example comprises two pendular weights riveted together.

It is known practice to choose the damping device, for example via the form of the rolling tracks, in such a way that the latter filters the order of excitation of a two-cylinder heat engine of the vehicle, also called “order 1”, the order of excitation of a heat engine being, as is known, the number of explosions of this engine per crankshaft revolution. Such devices are highly sensitive to the force of gravity, the latter then being able to cause undesirable displacements of the pendular bodies, and therefore affect the filtering performance levels.

To remedy this problem, it is for example known practice from the application DE 10 2012 221 103 to provide springs between two circumferentially adjacent pendular bodies, such that the duly linked pendular bodies withstand the force of gravity exerted revolution by revolution thereon when the device is driven by a rotational movement. The insertion of these springs presupposes forming additional housings in the pendular bodies or providing appropriate fixing means on these pendular bodies, which is costly and complex. Because of the insertion of the springs, an additional resonance frequency also appears. The insertion of the springs may also require open cutouts to be formed in the support of the device, then reducing the displacement of the pendular bodies. Furthermore, it is necessary to correctly dimension the springs and the maintenance over time of the characteristics of the springs is not guaranteed.

The object of the invention is to reduce the influence of gravity on the pendular bodies, particularly when the purpose of the latter is to filter the order of excitation of a two-cylinder heat engine of the vehicle, while wholly or partly remedying the above drawbacks.

The invention achieves this, according to one of its aspects, using a device for damping torsional oscillations, comprising:

at least one support capable of being displaced rotationally about an axis,

a plurality of pendular bodies, each pendular body being mobile in relation to the support, and

a friction-based connection between two circumferentially adjacent pendular bodies.

Within the meaning of the present application, two circumferentially adjacent pendular bodies are linked by a friction-based connection. A friction-based connection is different from the spring-based connection which is known from the abovementioned prior art. The connection according to the invention involves the presence of friction surfaces between the two circumferentially adjacent pendular bodies, these friction surfaces cooperating such that the displacement of one of these two pendular bodies is transmitted to the other of these two pendular bodies. The friction-based connection notably implements an axial friction, that is to say that the friction surfaces cooperating with one another are axially facing.

Such a friction-based connection between two circumferentially adjacent pendular bodies makes it possible to limit the displacement thereof under the effect of gravity and thus impedes the action of gravity on the pendular bodies. When the support rotates, each pendular body successively occupies the highest position about the axis of rotation of the support. A pendular body occupying such a position is linked via the friction-based connection to another pendular body which is lower and therefore less subject to the action of gravity. The downward displacement of the highest pendular body is transmitted via the friction-based connection to this other pendular body which then opposes this downward displacement.

The friction-based connection may allow the appearance of a hysteresis phenomenon for the displacement of the two pendular bodies that it links, the displacement under the effect of gravity of one of these pendular bodies being transmitted with a certain delay to the other pendular body.

The friction-based connection is advantageously dimensioned so as to reduce the displacement of the pendular bodies under the effect of gravity without affecting the performance levels of filtering of the torsional oscillations by the displacement of the pendular bodies.

Within the meaning of the present application:

“axially” means “parallel to the axis of rotation of the support”,

“radially” means “along an axis belonging to a plane orthogonal to the axis of rotation of the support and intersecting this axis of rotation of the support”,

“angularly” or “circumferentially” means “about the axis of rotation of the support”,

“orthoradially” means “at right angles to a radial direction”, and

“integral” means “rigidly coupled”.

Still within the meaning of the present application, the rest position of the device is the position thereof in which the pendular bodies are subject to a centrifugal force, but not to torsional oscillations originating from the rotational irregularities of the heat engine.

The device comprises, for example, a plurality of friction-based connections, such that, for each pendular body:

there is a friction-based connection with the pendular body that is circumferentially adjacent in the counter-clockwise direction, and

there is a friction-based connection with the pendular body that is circumferentially adjacent in the clockwise direction.

All the pendular bodies can thus be linked in pairs by a friction-based connection.

In all the above, the device comprises, for example, a number of pendular bodies lying between two and eight, in particular three or six pendular bodies. All these pendular bodies can follow one another circumferentially. The device can thus comprise a plurality of planes at right angles to the axis of rotation, in each of which all the pendular bodies are positioned.

Each friction-based connection can be of a first type, whereby it is produced using at least one tab integral to one of the two circumferentially adjacent pendular bodies and rubbing against the other of the two pendular bodies. This tab is, for example, produced of a single piece with the pendular body to which it is integral. As a variant, this tab is distinct from the two pendular bodies linked by the friction-based connection and it is fixed to one of these two pendular bodies. The tab is, for example, screwed onto one of the two pendular bodies. The tab can, according to this variant, be produced in a material suited to friction on a pendular body.

The tab is advantageously produced in an elastically deformable material. The tab is for example produced in plastic material or in spring-type steel.

The tab can, as a variant, be produced in several distinct materials. The part of the tab rubbing against the one of the two pendular bodies is for example produced in a material suited to friction, for example steel, whereas the part of the tab integral to the other of the two pendular bodies is for example produced in a material suited to the retention of the tab on this pendular body, for example in carbon fibers.

Each tab can have a fixing part on one of the two pendular bodies and a free end rubbing against the other of the two pendular bodies, the part of this tab positioned between the fixing part and the free end of the tab is then in particular undulated. The free end of the tab can be bent back.

When the device is at rest, each tab can extend substantially circumferentially between its fixing part on one of the two pendular bodies and its free end rubbing against the other of the two pendular bodies.

Each tab can be such that its free end is permanently axially facing the pendular body to which it is not integral, such that this free end can rub against this pendular body. In other words, the tab can be dimensioned and positioned in such a way as to extend over a distance such that its free end remains permanently facing a portion of the pendular body against which it is intended to rub, regardless of the relative positions of the two pendular bodies linked by the friction-based connection.

The friction-based connection can even be produced otherwise, of a second type whereby this connection is made other than via a tab integral to one of the two pendular bodies and rubbing against the other of the two pendular bodies.

According to this second type, the friction-based connection is produced via a piece extending all around the axis of rotation of the support and mobile in relation to the support, this piece rubbing against each pendular body. All the friction-based connections of the device are then made via one and the same piece. According to this second type, all the pendular bodies of the device are connected together by friction via this same piece. The movement of all the pendular bodies of the device is thus harmonized.

This piece is for example produced in an elastically deformable material.

As a variant, the part of this piece rubbing on the pendular bodies is for example produced in a material suited to this friction, for example in steel, while the rest of this piece can be produced in another material.

The piece allowing friction-based connections to be established between all the circumferentially adjacent pendular bodies of the device can have an annular part from which tabs protrude radially inward. Each pendular body is for example associated with only one tab. As a variant, several tabs rub against one and the same pendular body.

As a variant, the piece allowing friction-based connections to be established between all the circumferentially adjacent pendular bodies of the device is formed only by an annular part, being without radially protruding tabs. This is for example a largely hollowed-out annular piece such as an annular washer. This washer can be a crinkle washer, axially speaking, such a crinkle washer then successively occupying different axial positions when it is moved about its axis.

Whether the friction-based connection is of the first type or of the second type, it can allow, when all the pendular bodies of the device are linked by such connections, for the separation between two circumferentially adjacent pendular bodies to be constant for all the pendular bodies of the device for speeds of rotation of the heat engine of the vehicle beyond a certain threshold. More specifically, if three pendular bodies are present, the separation between the pendular bodies 1 and 2 will, for these speeds, be equal to that between the pendular bodies 2 and 3 and equal to that between the pendular bodies 3 and 1. Such a constant separation can for example be obtained for speed values for which the pendular bodies are not yet brought into their radially outermost position under the effect of the centrifugal force, these speed values correspond for example to the acceleration or deceleration.

Throughout the above, the device can comprise a plurality of rolling members, each rolling member cooperating with a first rolling track integral to the support and with a second rolling track integral to a pendular body, the displacement of each pendular body in relation to the support being guided by at least two of these rolling members.

The form of the first and second rolling tracks can be such that each pendular body is displaced in relation to the support both:

translationally about a hypothetical axis parallel to the axis of rotation of the support and,

also rotationally about the center of gravity of said pendular body, such a movement being also called “combined movement” and disclosed for example in the application DE 10 2011 086 532.

This combined movement can be qualified as 100% combined movement. The expression 100% combined movement is used for a pendular body when, in the position of rest of the device, in a plane at right angles to the axis of rotation, the normal to the contact between a first rolling track and one of the rolling members guiding the displacement of this pendular body, and the normal to the contact between another first rolling track and the other of the rolling members guiding the displacement of this pendular body are secant to the axis of rotation of the support.

As a variant, the form of the abovementioned first and second rolling tracks can be such that each pendular body is displaced only in relation to the support translationally about a hypothetical axis parallel to the axis of rotation of the support.

The support can comprise a plurality of windows in each of which two rolling members are received, one of these rolling members cooperating with a second rolling track integral to one of the two circumferentially adjacent pendular bodies and the other of these rolling members cooperating with a second rolling track integral to another of these two circumferentially adjacent pendular bodies. In this case, each friction-based connection of the first type can be positioned in a window between the two rolling members present in this window.

As a variant, each window formed in the support receives two rolling members guiding the displacement in relation to the support of a single pendular body.

As another variant, each window formed in the support receives only a single rolling member.

Throughout the above, the device can comprise a plurality of abutment damping members, each abutment damping member being positioned so as to be interposed between a part of a pendular body and a part of the support so as to damp the shocks between the latter. These shocks correspond for example to the pendular body coming into abutment against the support at the end of a displacement of this pendular body to filter a torsional oscillation or to the radial drop of this pendular body when engine of the vehicle stops.

Each abutment damping member is for example produced in rubber or in elastomer. The abutment damping member can exhibit, in cross section, a cylindrical or non-cylindrical form.

According to a first exemplary implementation of the invention, the support is singular and each pendular body comprises:

a first and a second pendular weight axially spaced apart from one another the first pendular weight being positioned axially on a first side of the support and the second pendular weight being positioned axially on a second side of the support, and

at least one link member of the first and of the second pendular weights, pairing said weights.

According to a first variant of this first exemplary implementation, each pendular body comprises two link members pairing the first and the second pendular weights, each link member defining a second rolling track cooperating respectively with one of the two rolling members guiding the displacement of this pendular body in relation to the support. Each rolling member cooperates here with a single second rolling track. A portion of the outline of this link member, for example a part of the radially outer surface of this link member or a coating deposited on this part of the radially outer surface of this link member, defines, for example, this rolling track integral to the pendular body. In this case, a part of the outline of the window in which this link member is positioned then defines the rolling track integral to the support with which the rolling member cooperates to guide the displacement in relation to the support of this pendular body.

Such a link member is for example force-fitted via each of its axial ends into an opening formed in one of the pendular weights. As a variant, the link member can be welded via its axial ends onto each pendular weight. The link member can even be screwed or riveted onto each pendular weight.

According to this first variant of the first exemplary implementation of the invention, each rolling member can then be stressed only in compression between the first rolling track integral to the support and the second rolling track integral to the pendular body as mentioned above. These rolling tracks cooperating with one and the same rolling member can be at least partly radially facing, that is to say that there are planes at right angles to the axis of rotation in which these rolling tracks both extend.

According to this first variant of the first exemplary implementation, the friction-based connection between two circumferentially adjacent pendular bodies is for example of the first type and it can implement two distinct tabs. A first tab is in particular positioned on the first side of the support while a second tab is positioned on the second side of the support. The presence of a tab on each side of the support makes it possible to balance the frictions which are exerted on the pendular body, and thus prevent the pendular weights forming this pendular body from being skewed in relation to the support. There would be a risk of such a skewing occurring if only one of the pendular weights of the pendular body were to undergo a friction due to the friction-based connection.

In such a case, the first tab is thus integral to a first pendular weight of one of the two pendular bodies and rubs against the first pendular weight of the other of the two pendular bodies. The second tab can act similarly between the second pendular weight of one of the two pendular bodies and the second pendular weight of the other of the two pendular bodies.

More specifically, the two tabs of the connection of the first type between the two pendular bodies can both be integral to the same pendular body and rub against the other pendular body. As a variant, the first tab is for example integral to the first pendular weight of one of the two pendular bodies and it rubs against the first pendular weight of the other of the two pendular bodies while the second tab is integral to the second pendular weight of the pendular body against which the first tab rubs and this second tab rubs against the second weight of the pendular body to which the first tab is integral. The first and the second tabs of each connection can be identical.

When each window formed in the support receives rolling members guiding the displacement in relation to the support of two different pendular bodies, the connection of the first type can implement only a single tab, and the latter is received in the window between the two rolling members. This tab is for example integral to a link member of one of the two pendular bodies, and it comes to rub against each pendular weight of the other of the two pendular bodies. The fixing pan of this tab has, for example, two axial ends which are secured to each pendular weight linked by this link member. The free end of this single tab for example has two anus extending substantially parallel and positioned between the two pendular weights of the other of the two pendular bodies, such that one of the arms comes to rub against the first pendular weight of the other of the two pendular bodies while the other of the arms comes to rub against the second pendular weight of the other of the two pendular bodies.

According to this first variant of the first exemplary implementation of the invention, this connection can be of the second type. The piece coming to rub on the pendular bodies for example takes the form of two flanges. Each flange can be positioned on one side of the support and bear tabs, for example produced of a single piece with the flange. Each tab then comes to be applied, in particular via its free end, against one of the pendular weights of a pendular body. Each tab can be made of plastic material or of spring-type steel.

Each tab can extend radially between the rest of the flange and its free end.

The piece is for example formed by:

a first flange positioned on the first side of the support and having a radially inner portion bearing first tabs, this radially inner portion of the first flange extending axially beyond the first pendular weights of the pendular bodies such that each first tab conies to rub against a first pendular weight, and

a second flange positioned on the second side of the support and having a radially inner portion bearing second tabs, this radially inner portion of the first flange extending axially beyond the second pendular weights of the pendular bodies such that each second tab comes to rub against a second pendular weight.

The first and the second flanges can be secured, for example by screws or rivets, via their radially outer portion. The centering of the piece formed by the first and second flanges is for example performed on the support. The radially outer portion of the two flanges can then define the abovementioned annular part of the piece.

According to a second variant of the first exemplary implementation of the invention, the support is still singular and each rolling member cooperates with two second rolling tracks integral to the pendular body, one of these second rolling tracks being defined by the first pendular weight and the other of these second rolling tracks being defined by the second pendular weight.

According to this second variant, the friction-based connection can be of the first type and as described with reference to the first variant of the first exemplary implementation of the invention, or the friction-based connection can be of the second type and as described with reference to the first variant of the first exemplary implementation of the invention.

According to this second variant, each link member is for example a rivet. The rivet can be received in a window of the support in which a rolling member is already received. As previously, a part of the outline of the window then defines the first rolling track integral to the support.

Each rolling member can, according to this second variant of the first exemplary implementation of the invention, comprise, in axial succession:

a portion positioned in a cavity of the first pendular weight and cooperating with the second rolling track formed by a part of the outline of this cavity,

a portion positioned in a window of the support and cooperating with the first rolling track formed by a part of the outline of this window, and

a portion positioned in a cavity of the second pendular weight and cooperating with the second rolling track formed by a part of the outline of this cavity.

According to a second exemplary implementation of the invention, the device comprises two distinct axially offset and integral supports, each pendular body comprising at least one pendular weight positioned axially between the two supports. Each pendular body can comprise several pendular weights, for example two or three pendular weights, which may or may not be secured to one another, and which are positioned axially between the two supports.

The pendular weight or weights of a pendular body are then sandwiched axially between the two supports. The two supports are for example secured via a link such as a riveting positioned radially inward in relation to the pendular bodies. Two caps can then be positioned axially around the assembly formed by the two supports and the pendular bodies. There can thus be, in axial succession:

one of the caps,

one of the supports,

the pendular weight or weights,

the other of the supports, and

the other of the caps.

According to a first variant of this second exemplary implementation of the invention, each pendular body has a protuberance protruding axially into a window of one of the supports, this protuberance defining a second rolling track integral to the pendular body.

Two protuberances can be provided on each side of a pendular weight or of the integral assembly of integral pendular weights, and, from one side to the other of the pendular weight or of this integral assembly of pendular weights, these protuberances can extend axially in opposite directions and be axially superposed. The two protuberances formed on a first side of the pendular weight or of the integral assembly of pendular weights then protrude into two different windows of one of the supports while the two protuberances formed on a second side opposite the first side of the pendular weight or of the integral assembly of pendular weights then protrude into two different windows of the other of the supports.

The displacement of a pendular body in relation to the support can, here, be guided by four rolling members:

a first rolling member cooperating with a first rolling track defined by a part of the outline of one of the windows formed in the support positioned on the first side of the pendular weight or of the integral assembly of pendular weights and with a second rolling track defined by one of the protuberances formed on this first side of the pendular weight or of the integral assembly of pendular weights,

a second rolling member cooperating with a first rolling track defined by a part of the outline of another window formed in the support positioned on the first side of the pendular weight or of the integral assembly of pendular weights and with a second rolling track defined by another of the protuberances formed on this first side of the pendular weight or of the integral assembly of pendular weights,

a third rolling member cooperating with a first rolling track defined by a part of the outline of one of the windows formed in the support positioned on the second side of the pendular weight or of the integral assembly of pendular weights and with a second rolling track defined by one of the protuberances formed on this second side of the pendular weight or of the integral assembly of pendular weights, and

a fourth rolling member cooperating with a first rolling track defined by a part of the outline of another window formed in the support positioned on the second side of the pendular weight or of the integral assembly of pendular weights and with a second rolling track defined by another of the protuberances formed on this second side of the pendular weight or of the integral assembly of pendular weights.

Each of these four rolling members can be stressed only in compression, as explained with reference to the first exemplary implementation of the invention.

According to this first variant, the friction-based connection between the pendular bodies can be of the first type or of the second type. When the connection is of the second type, the piece rubbing against each pendular body can be an annular washer whose radially outer dimension is preferably less than that of the pendular bodies. A housing can be formed in the single pendular weight or in the integral assembly of pendular weights, such that the washer is axially positioned inside the single pendular weight or the integral assembly of pendular weights. The washer can thus rub against one of the axial edges of the housing in which it is received.

When the washer is axially undulated, it can come to rub successively against each axial edge of the housing formed in the single pendular weight or in the integral assembly of pendular weights.

According to this first variant, each pendular weight or each integral assembly of pendular weights is then not passed through by a rolling member.

According to a second variant of this second exemplary implementation of the invention, the pendular weight or each weight of the integral assembly of pendular weights has at least two through cavities, such that each rolling member is received:

in a window formed in one of the two supports,

in a cavity formed in the pendular weight or in each of the weights of the integral assembly of pendular weights, and

in a window formed in the other of the two supports.

According to this second variant, each friction-based connection can be of the first type or of the second type. When the friction-based connection is of the second type, the piece rubbing against each pendular body can be an annular washer, for example an annular crinkle washer, as mentioned previously.

Throughout the above, the surface of the pendular body involved in the friction-based connection, for example that against which a tab rubs when there is such a tab in the friction-based connection, can be provided with a track promoting the friction. This track can be formed by a pellet, particularly of steel, added on to this surface or by modification of the form of this surface, for example by hollowing out this surface.

Throughout the above, the device for damping torsional oscillations can be configured such that the displacement of the pendular bodies makes it possible to filter the order of excitation of the heat engine of the vehicle in which the device is incorporated, this heat engine having in particular two cylinders or three cylinders.

Throughout the above, each support can be produced of a single piece, being for example entirely metal.

Throughout the above, the device can comprise at least one interposition piece of which at least a part is axially positioned between a support and a pendular weight of the pendular body. Such an interposition piece can thus limit the axial displacement of the pendular body in relation to the support, thus preventing the axial shocks between said pieces, and thus an undesirable wear and noises, particularly when the support and/or the pendular weight are of metal. Several interposition pieces, for example in the form of skids, can be provided. The interposition pieces are in particular produced in a damping material, such as plastic or rubber.

The interposition pieces are for example borne by the pendular bodies. The interposition pieces can be positioned on a pendular body such that there is always at least one interposition piece of which at least a part is axially interposed between a pendular weight and the support, regardless of the relative positions of the support and of said weight in the displacement in relation to the support of the pendular body.

Throughout the above, the device can comprise:

at least one first pendular body making it possible to filter a first order value of the torsional oscillations, and

at least one second pendular body making it possible to filter a second order value of the torsional oscillations, different from the first order value.

Another subject of the invention, according to another of its aspects, is a component for a transmission system of a motor vehicle, the component being in particular a dual mass flywheel, a hydrodynamic torque converter, a friction clutch disk, a crankshaft-integral flywheel, a dry or wet double clutch, a wet single clutch, or even a component of a hybrid power train, comprising a damping device as defined previously.

The support of the device for damping torsional oscillations can then be one out of:

a web of the component,

a guiding washer of the component,

a phasing washer of the component, or

a support distinct from said web, from said guiding washer and from said phasing washer.

Another subject of the invention, according to another of its aspects, is a vehicle power train comprising:

a propulsion heat engine of the vehicle, in particular with two, three or four cylinders, and

a component for a transmission system as defined above.

If necessary, a cylinder deactivation system can make it possible to only have the heat engine operate with only some of these cylinders active. The engine can thus exhibit a mode of operation in which only two of its cylinders are active and the pendular bodies can then aim to filter the order of excitation of this engine in this mode of operation.

The invention will be able to be better understood on reading the following description of nonlimiting exemplary implementations thereof and on studying the attached drawing in which:

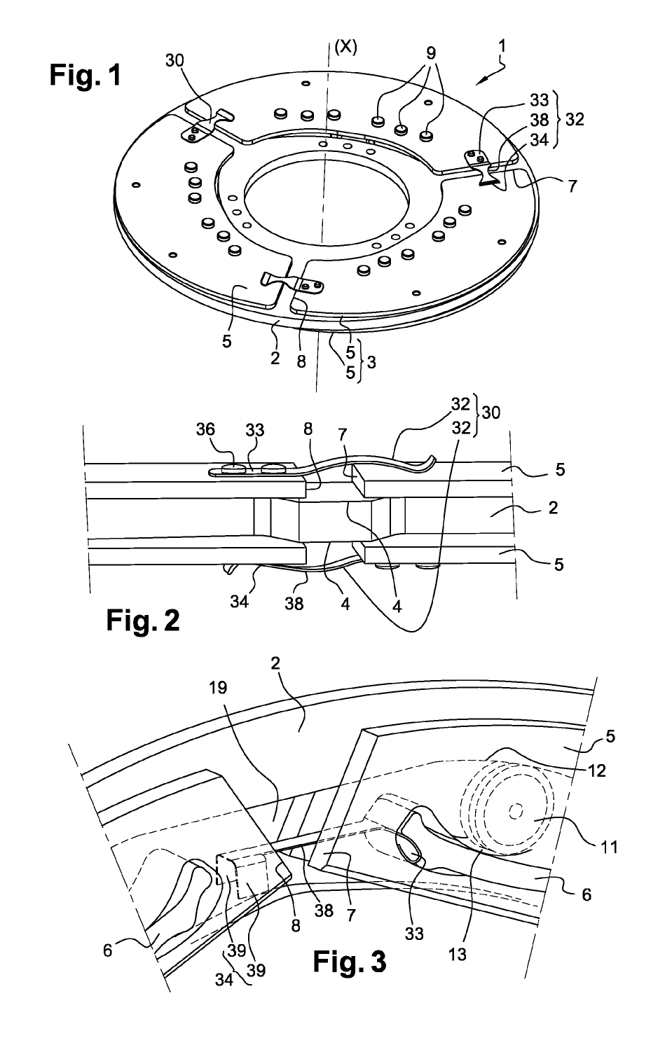

FIG. 1 represents a device for damping torsional oscillations according to a first variant of a first exemplary implementation of the invention,

FIG. 2 represents a detail of the device of FIG. 1,

FIG. 3 represents an alternative to what is represented in FIG. 2,

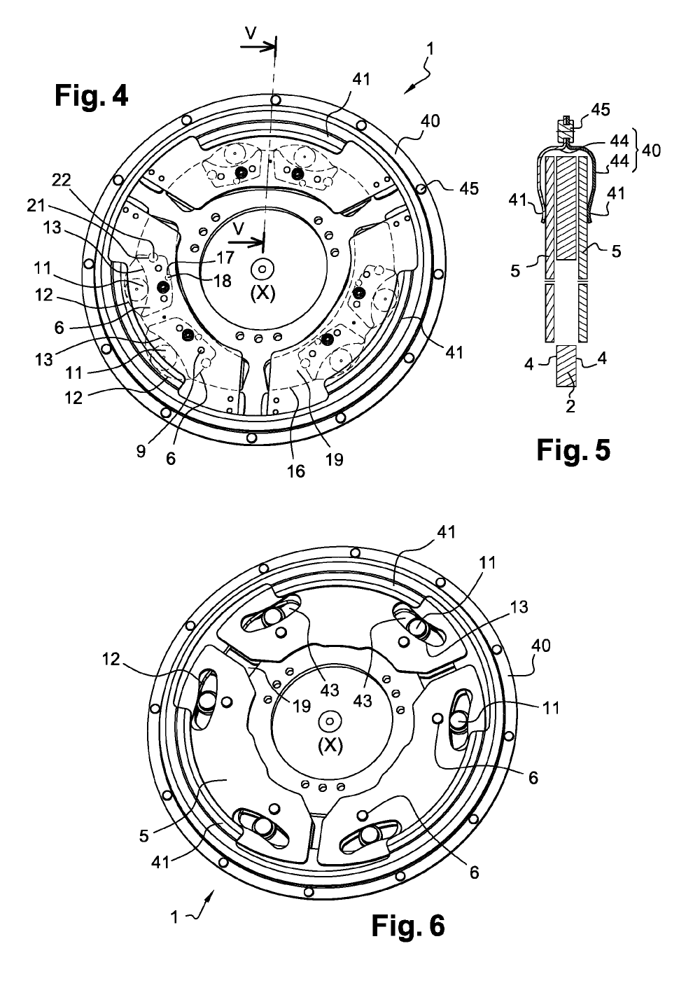

FIGS. 4 and 5 represent another alternative to what is represented in FIG. 2, FIG. 5 being a view in cross section along V-V of FIG. 4,

FIG. 6 represents, like FIG. 4, a device for damping torsional oscillations according to a second variant of the first exemplary implementation of the invention,

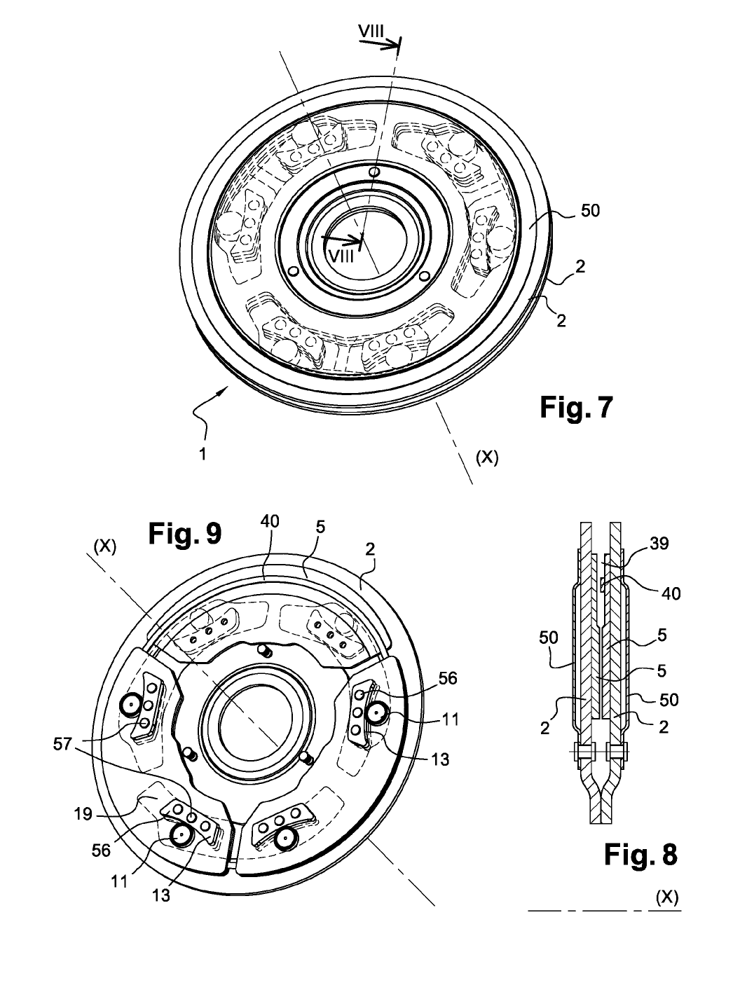

FIGS. 7 to 9 represent a device for damping torsional oscillations according to a first variant of a second exemplary implementation of the invention, FIG. 8 being a view in cross section along VIII-VIII of FIG. 7, and FIG. 9 differing from FIG. 7 by the fact that one of the supports is not represented therein and by the fact that the pendular bodies are not fully represented therein, and

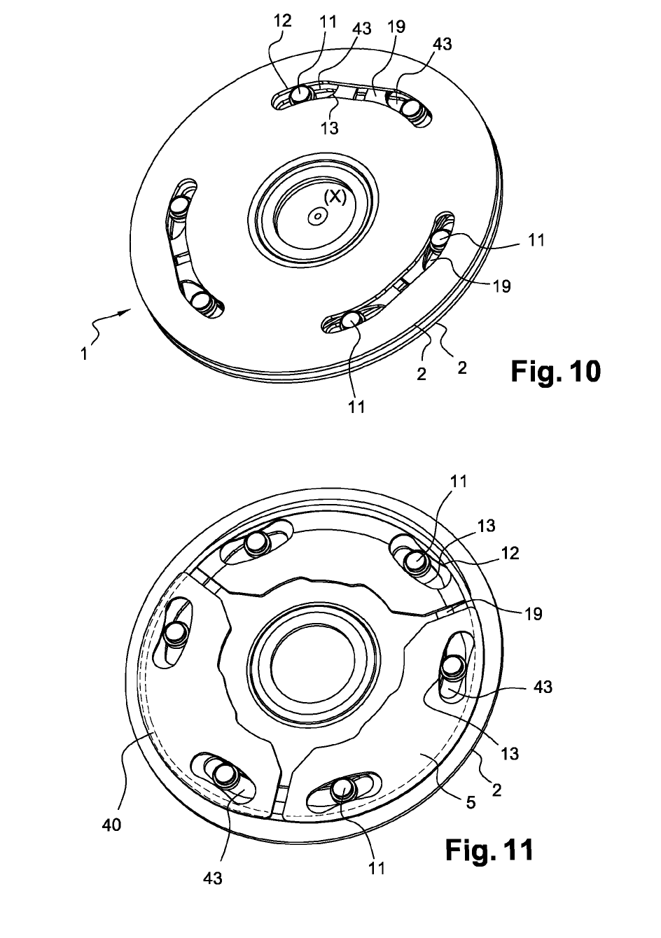

FIGS. 10 and 11 represent a device for damping torsional oscillations according to a second variant of a second exemplary implementation of the invention, FIG. 11 differing from FIG. 10 by the fact that one of the supports is not represented therein and by the fact that the pendular bodies are not fully represented therein.

FIG. 1 shows a device 1 for damping torsional oscillations according to a first variant of a first exemplary implementation of the invention.

The damping device 1 is of pendular oscillator type. The device 1 is in particular capable of equipping a motor vehicle transmission system, being for example incorporated in a component (not represented) of such a transmission system, this component being, for example, a dual mass flywheel, a hydrodynamic torque converter or a clutch disk.

This component can form part of a power train of a motor vehicle, this power train comprising a heat engine in particular with two, three or four cylinders.

In FIG. 1, the device 1 is at rest, that is to say that it does not filter the torsional oscillations transmitted by the propulsion chain because of the rotational irregularities of the heat engine.

As is known, such a component can comprise a torsion damper having at least one input element, at least one output element, and circumferentially-acting elastic return members which are interposed between said input and output elements. Within the meaning of the present application, the terms “input” and “output” are defined in relation to the direction of transmission of the torque from the heat engine of the vehicle to the wheels thereof.

In the example considered, the device 1 comprises:

a support 2 capable of being rotationally displaced about an axis X, and

a plurality of pendular bodies 3 that are mobile in relation to the support 2.

According to the first exemplary implementation of the invention, which will be described with reference to FIGS. 1 to 6, the support 2 is singular. It will be noted also in FIGS. 1 to 6 that three pendular bodies 3 are provided, being distributed uniformly over the perimeter of the axis X.

The support 2 of the damping device 1 can be composed of:

an input element of the torsion damper,

an output element or an intermediate phasing element positioned between two series of springs of the damper,

an element rotationally linked to one of the abovementioned elements and distinct therefrom, being then for example a support specific to the device 1.

The support 2 is in particular a guiding washer or a phasing washer. The support can also be something else, for example a flange of the component.

In the example considered, the support 2 is overall in the form of a ring comprising two opposite sides 4 which here are planar faces.

As can notably be seen in FIGS. 1 to 5, each pendular body 3 comprises, in the example considered:

two pendular weights 5, each pendular weight 5 extending axially facing a side 4 of the support 2, and

two link members 6 securing the two pendular weights 5.

The link members 6, also called “spacers”, can be seen better in FIGS. 3 and 4, and in the examples considered, they are angularly offset. Each body 3 extends angularly between two circumferential ends, which correspond respectively to the circumferential ends 7 and 8 of the pendular weights 5 of this body.

In the, example of FIGS. 1 and 2 and in the example of FIGS. 4 and 5, each link member 6 is screwed onto one of the pendular weights 5 via screws 9 that can be seen in FIG. 1 so as to secure the latter to one another. In the alternative represented in FIG. 3, each end of a link member 6 is force-fitted into an opening formed in one of the pendular weights 5 of the pendular body 3, so as to secure these two pendular weights 5 to one another.

In yet another alternative, each end of a link member 6 is secured to one of the pendular weights 5 by welding.

In yet another alternative, each link member is riveted to one of the pendular weights 5.

The device 1 also comprises rolling members 11 that can be seen in FIGS. 3 and 4 for example, guiding the displacement of the pendular bodies 3 in relation to the support 2. The rolling members 11 here are rollers.

In the example described, the movement in relation to the support 2 of each pendular body 3 is guided by two rolling members 11. This movement is for example a combined movement.

Each rolling member 11 is received in a window 19 formed in the support 2. In the example of FIGS. 1 and 2 and in the example of FIGS. 4 and 5, one and the same window 19 formed in the support 2 receives the two rolling members 11 guiding the displacement of a pendular body 3 in relation to the support 2.

Each window 19 has a closed outline 16 and a part of this outline 16 defines a first rolling track 12 integral to the support 2, on which one of the rolling members 11 received in this window 19 will roll, while another part of this closed outline 16 defines another first rolling track 12 integral to the support 2, on which the other rolling member 11 received in the window 19 will roll.

In the example of FIG. 3, one and the same window formed in the support 2 receives a rolling member 11 guiding the displacement of a pendular body 3 in relation to the support and a rolling member 11 guiding the displacement of a circumferentially adjacent pendular body in relation to the support 2. Each window 19 has a closed outline 16, this closed outline having a part defining a first rolling track 12 integral to the support 2, on which one of the rolling members 11 received in this window 19 will roll, while another part of this closed outline 16 defines another first rolling track 12 integral to the support 2, on which the other rolling member 11 received in the window 19 will roll.

In the example of FIGS. 1 to 5, each window 19 also receives two link members 6 of the pendular body 3.

Each link member 6 defines, in the example of FIGS. 1 to 5, a second rolling track 13 which is integral to the pendular body 3 to which this link member 6 belongs and on which one of the rolling members 11 rolls to guide the displacement of this pendular body 3 in relation to the support 2.

Each link member 6 has, in the, example of FIGS. 1 and 2 and in the example of FIGS. 4 and 5, on its radially inner edge, a notch 17 in which an abutment damping member 18 is received and, on its lateral edge 20 not facing the other link member 6 received in this window 19, a notch 21 in which another abutment damping member 22 is received. The abutment damping members 18 and 22 are for example produced in elastomer or in rubber. These abutment damping members 18 and 22 damp the shocks between the pendular body 3 and the support in case of radial drop when the engine of the vehicle stops and/or on completion of a travel of this pendular body 3 to filter a torsional oscillation.

According to the invention, two circumferentially adjacent pendular bodies 3 are linked by a friction-based connection 30. More specifically, in the examples described, the device 1 comprises a plurality of friction-based connections 30, such that, for each pendular body 3:

there is a friction-based connection 30 with the circumferentially adjacent pendular body 3 in the counter-clockwise direction, and

there is a friction-based connection 30 with the circumferentially adjacent pendular body 3 in the clockwise direction.

In FIGS. 1 and 2, which correspond to a first variant of a first exemplary implementation of the invention, this connection is of a first type.

In the example of FIGS. 1 and 2, each friction-based connection 30 implements two tabs 32, As can be seen more specifically in FIG. 2, each tab 32 can have a fixing part 33 on one of the pendular bodies 3 and a free end 34 rubbing against the other of the two pendular bodies 3. The fixing of a tab 32 on one of the pendular bodies 3 is performed in the example represented via screws 36, In the example of FIGS. 1 and 2, each free end 34 is bent back and the part 38 of a tab positioned between the fixing part 33 and the free end 34 is undulated. As can be seen in particular in FIG. 1, when the device 1 is at rest, each tab 32 extends substantially circumferentially between its fixing part 33 and its free end 34. Still in the example considered, each tab 32 is such that its free end 34 is permanently axially facing the pendular body 3 against which it has to rub.

In the example of FIGS. 1 and 2, a first tab 32 is positioned on the first side of the support and it is integral to the first pendular weight 5 of one of the pendular bodies 3 and rubs against the first pendular weight 5 of the other pendular body 3 while a second tab 32 is positioned on the second side 4 of the support 2 and this second tab 32 is integral to the second pendular weight 5 of the pendular body against which the first tab 32 rubs, and this second tab 32 rubs against the second pendular weight 5 of the pendular body 3 to which the first tab 32 is integral. Within one and the same friction-based connection, the mounting of the tabs 32 can thus be reversed.

Within one and the same friction-based connection 30, the first and second tabs 32 can be identical and produced in plastic or in spring-type steel.

FIG. 3 represents a variant friction-based connection 30 of the first type. According to this variant, the friction-based connection 30 implements a single tab 32 and this tab extends into the window 19 formed in the support 2 and which receives rolling members 11 guiding the displacement of two circumferentially adjacent pendular bodies. The fixing part 33 is, here, force-fitted into an opening formed in each pendular weight 5 and the part 38 extends into the window 19 between the two pendular bodies 3. The free end 34 here has two arms 39 extending substantially parallel, these two arms 39 being both positioned in the axial space delimited by the two pendular weights 5 of the pendular body 3 against which the single tab 32 rubs. These two arms 39 are such that each of them comes to rub against one of the pendular weights 5.

There now follows a description with reference to FIGS. 4 and 5 of an example of a second type of friction-based connection 30. According to the second type, as described with reference to FIGS. 4 and 5, all the friction-based connections between the pendular bodies 3 of the device implement a piece 40 extending all around the axis of rotation X of the support 2 and mobile in relation to the support 2. This piece 40 comes to rub against each pendular body 3. The piece 40 defines tabs 41 which will be described later, each tab protruding radially inward.

As can be seen in particular in FIG. 5, in which the link members 6 and the rolling members 11 are not represented, the piece 40 can take the form of two flanges 44 rigidly connected to one another via rivets 45 at their radially outer portion.

As can be seen in FIG. 5, a first flange 44 is positioned on a first side 4 of the support 2 and extends axially beyond the first pendular weight 5 such that one or more of the first tabs 41 that it bears come to rub against this first pendular weight 5. Likewise, a second flange 44 is positioned on a second side 4 of the support 2 and it extends axially beyond the second pendular weight 5 such that one or more second tabs 41 that it bears come to rub against this second pendular weight 5.

There now follows a description with reference to FIG. 6 of a second variant of the first exemplary implementation of the invention. According to this second variant, each rolling member 11 cooperates with two second rolling tracks 13 that are distinct and integral to a pendular body 3.

One of the second rolling tracks 13 is defined by the first pendular weight 5 of the pendular body 3 and the other of these second rolling tracks 13 is defined by the second pendular weight 5 of this pendular body 3. Each pendular weight 5 has, in this example, two cavities 43, and each of these cavities 43 receives a part of a rolling member 11 which cooperates with the second rolling track 13 formed by a part of the outline of this cavity 40. The first rolling track 12 with which this rolling member 11 cooperates is, as previously, formed by a part of the outline 16 of the window 19.

In the example of FIG. 6, each link member 6 is a rivet which is also received in the window 19.

According to the second variant of the first exemplary implementation of the invention which is described with reference to FIG. 6, the friction-based connection 30 between two circumferentially adjacent pendular bodies is of the second type described above, implementing, like what is described with reference to FIGS. 4 and 5, a piece 40 having two flanges 44 respectively bearing first tabs 41 rubbing against the first pendular weights 5 and second tabs 41 rubbing against the second pendular weights 5. Each first tab 41 and each second tab 41 extends over a given angular segment.

FIGS. 1 to 6 relate to the first exemplary implementation of the invention, whereby the device 1 comprises a single support and each pendular body 3 comprises two paired pendular weights each extending on one side 4 of the support 2.

There now follows a description, with reference to FIGS. 7 to 11, of two variants of a device for damping torsional oscillations according to a second exemplary implementation of the invention.

According to this second exemplary implementation of the invention, the device comprises two distinct axially offset and integral supports 2. Each pendular body 3 can comprise, according to this second exemplary implementation of the invention, a single pendular weight 5 positioned axially between the two supports 2. In the description below, each pendular body 3 comprises two pendular weights 5 secured to one another and which, as can be seen in FIG. 8, have forms allowing a housing 39 to be formed between the radially outer parts of these two pendular weights 5. The two integral pendular weights 5 are positioned axially between the two supports 2. In FIG. 9, only one of the two pendular weights 5 of a pendular body 3 is represented.

In the example of FIGS. 7 to 9, two caps 50 are positioned axially around the assembly formed by the two supports 2 and the pendular bodies 3, such that there are, in axial succession:

one of the caps 50,

one of the supports 2,

the two pendular weights 5,

the other of the supports 2, and

the other of the caps 50.

According to a first variant of this second exemplary implementation of the invention, which is represented in FIGS. 7 to 9, each pendular body 3 has a protuberance 56 protruding axially into a window 19 of one of the supports 2. This protuberance 56, which may or may not be produced of a single piece with one of the two pendular weights 5 of the pendular body 3, here defines a second rolling track 13 integral to the pendular body.

In the example represented in FIGS. 7 to 9, two protuberances 56 are provided on each side of the two pendular weights 5. From one side to the other of the two pendular weights 5, these protuberances can extend axially in opposite directions and be axially superposed. Two axially superposed protuberances 56 can be linked together and to the two pendular weights 5 via rivets 57, as represented in FIGS. 7 and 9.

As can be worked out in FIG. 8, the two protuberances 56 formed on a first side of the two pendular weights 5 then protrude into two different windows 19 of one of the supports 2 while the two protuberances 56 formed on a second side of the two pendular weights 5, opposite the first side, then protrude into two different windows 19 of the other of the two supports 2 of the device 1.

In the example considered, the displacement of each pendular body 3 in relation to the support 2 is guided by four distinct rolling members 11:

a first rolling member 11 cooperating with a first rolling track 12 defined by a part of the outline of one of the windows 19 formed in the support 2 positioned on the first side of the two pendular weights 5 and with a second rolling track 13 defined by one of the protuberances 56 formed on this first side of the two pendular weights 5,

a second rolling member 11 cooperating with a first rolling track 12 defined by a part of the outline of another window 19 formed in the support 2 positioned on the first side of the two pendular weights 5 and with a second rolling track 13 defined by another of the protuberances 56 formed on this first side of the two pendular weights 5,

a third rolling member 11 cooperating with a first rolling track 12 defined by a part of the outline of one of the windows 19 formed in the support 2 positioned on the second side of the two pendular weights 5 and with a second rolling track 13 defined by one of the protuberances 56 formed on this second side of the two pendular weights 5, and

a fourth rolling member 11 cooperating with a first rolling track 12 defined by a part of the outline of another window 19 formed in the support 2 positioned on the second side of the two pendular weights 5 and with a second rolling track 13 defined by another of the protuberances 56 formed on this second side of the two pendular weights 5.

In the example of FIGS. 7 to 9, each pendular body 3 is linked to the two pendular bodies 3 between which it is circumferentially positioned by means of a connection of the second type, the latter involving a piece 40 which differs from those described with reference to FIGS. 4 to 6 by the fact that this piece 40 is an annular washer. The piece 40 here is without tabs and it extends all around the axis of rotation X of the support, so as to be able to rub against each pendular body 3 of the device 1. The washer is received in the housing 39 and defines a succession of portions. The washer 40 here is a crinkle washer, for example of Onduflex® type, and it thus occupies different successive axial positions in the housing 39.

Two successive portions of this washer 40 received in the housing 39 can thus rub against two different axial edges of this housing 39, that is to say against two different pendular weights 5 of the pendular body 3.

FIGS. 10 and 11 represent a second variant of this second exemplary implementation of the invention.

According to this second variant, each pendular weight 5 has at least two through cavities 43, such that each rolling member 11 is received:

in a window 19 formed in one of the two supports 2,

in a cavity 43 formed in the pendular weight 5, and

in a window 19 formed in the other of the two supports 2.

According to this second variant as described with reference to FIGS. 10 and 11, the friction-based connection 30 between two circumferentially adjacent pendular bodies 3 is again of the second type and the piece 40 is a washer that comes to rub against each pendular body 3 of the device, like what was described with regard to the first variant of this second exemplary implementation of the invention.

The invention is not limited to the examples which have just been described.

It is for example possible to combine together features described with reference to different embodiments.

By way of examples, a friction-based connection 30 of the first type can be used in the examples described with reference to FIGS. 6 to 11.

The figures of the present application are views that are to scale, such that measurements can be obtained therefrom by the person skilled in the art.

1. A device for damping torsional oscillations, comprising:
at least one support capable of being displaced rotationally about an axis,
a plurality of pendular bodies, each pendular body being mobile in relation to the support (2), and
a friction-based connection between two circumferentially adjacent pendular bodies, the friction-based connection implementing a friction between axially facing friction surfaces.

2. The device as claimed in claim 1, comprising a plurality of friction-based connections, such that, for each pendular body:
there is a friction-based connection with the pendular body that is circumferentially adjacent in the counter-clockwise direction, and
there is a friction-based connection with the pendular body that is circumferentially adjacent in the clockwise direction.

3. The device as claimed in claim 2, the friction-based connection being produced using at least one tab integral to one of the two circumferentially adjacent pendular bodies and rubbing against the other of these two pendular bodies.

4. The device as claimed in claim 3, the tab having a fixing part on one of the two pendular bodies and a free end rubbing against the other of the two pendular bodies, the part of this tab positioned between the fixing part and the free end of the tab being in particular undulated.

5. The device as claimed in claim 4, the tab being such that its free end is permanently axially facing the pendular body to which it is not integral, such that this free end can rub against this pendular body.

6. The device as claimed in claim 1, the friction-based connection being produced via a piece extending all around the axis of rotation of the support and mobile in relation to the support, this piece rubbing against each pendular body.

7. The device as claimed in claim 1, comprising
a plurality of rolling members, each rolling member cooperating with a first rolling track integral to the support and with a second rolling track integral to a pendular body, the displacement of each pendular body in relation to the support being guided by at least two of these rolling members.

8. The device as claimed in claim 7, the support comprising a plurality of windows in each of which two rolling members are received, one of these rolling members cooperating with a second rolling track integral to one of the two circumferentially adjacent pendular bodies and the other of these rolling members cooperating with a second rolling track integral to another of these two circumferentially adjacent pendular bodies,
each friction-based connection being positioned in a window between the two rolling members present in this window.

9. The device as claimed in claim 1, the support being singular and each pendular body comprising:
a first and a second pendular weight axially spaced apart from one another, the first pendular weight being positioned axially on a first side of the support and the second pendular weight being positioned axially on a second side of the support, and
at least one link member of the first and of the second pendular weights, pairing said weights.

10. The device as claimed in claim 9, each pendular body comprising two link members pairing the first and the second pendular weights, each link member defining a second rolling track cooperating respectively with one of the two rolling members guiding the displacement of this pendular body in relation to the support.

11. The device as claimed in claim 9, each rolling member cooperating with two second rolling tracks integral to the pendular body, one of these second rolling tracks being defined by the first pendular weight and the other of these second rolling tracks being defined by the second pendular weight.

12. The device as claimed in claim 10,
wherein the friction-based connection is produced using at least one tab integral to one of the two circumferentially adjacent pendular bodies and rubbing against the other of these two pendular bodies, each friction-based connection comprising:
a first tab positioned on the first side of the support, the first tab being integral to a first pendular weight of one of the two pendular bodies and rubbing against the first pendular weight of the other of the two pendular bodies, and
a second tab positioned on the second side of the support, the second tab being integral to a second pendular weight of one of the pendular bodies and rubbing against the second pendular weight of the other of the two pendular bodies.

13. The device as claimed in claim 1, comprising two distinct axially offset and integral supports, each pendular body comprising at least one pendular weight positioned axially between the two supports.

14. The device as claimed in claim 1, being configured such that the displacement of the pendular bodies makes it possible to filter the order of excitation of a two-cylinder vehicle heat engine.

15. A component for a transmission of a motor vehicle system, comprising a device for damping torsional oscillations as claimed in claim 1,
the component being in particular a dual mass flywheel, a hydrodynamic torque converter, a friction clutch disk, a crankshaft-integral flywheel, a dry or wet doable clutch, a wet single clutch, or a component of a hybrid power train.
